(19) United States
(12) Patent Application Publication
(10) Pub. No.: US 2003/0075028 A1
(43) Pub. Date: Apr. 24, 2003

(54) Hand tool machine with a pivotable tool cover

(76) Inventors: Albrecht Hofmann, Steinbronn (DE); Harald Krondorfer, Ludwigsburg (DE); Thomas Schomisch, Leinfelden-Echterdingen (DE)

Correspondence Address: Striker Striker & Stenby, 103 East Neck Road, Huntington, NY, 11743, US

(21) Appl. No.: 10/258,427

(22) PCT Filed: Dec. 21, 2001
(86) PCT No.: PCT/DE01/04851

(30) Foreign Application Priority Data
Mar. 2, 2001 (DE) 101 10 119.8

(51) Int. Cl. B26D 5/08

(52) U.S. Cl. 81/466; 83/544; 83/564

(57) ABSTRACT

The invention is based on a hand power tool with a disk-shaped tool (14) that can be driven to rotate around a rotation axis (16), in particular a manually guided right angle grinder, a manually guided circular saw, or the like, including a pivoting tool cover (22).

The invention proposes that the tool cover (22) have an essentially curved end face and be embodied so that it can move essentially parallel to the plane of the disk-shaped tool (14) in order to unblock this tool, that when actuated, the end face of the tool cover (22) move across at least part of the surface of the disk-shaped tool (14) in a direction lateral to the circumference direction of the tool.

### PRIOR ART

The invention is based on a hand power tool with a disk-shaped tool that can be driven to rotate according to the preamble to claim 1.

A hand power tool of this kind can, for example, be embodied as a manually guided right angle grinder or a manually guided circular saw.

In a manually guided right angle grinder known from actual use, a synthetic resin-bonded cutting wheel, which represents the disk-shaped tool, is covered over approximately 180° of its circumference by a protective hood. The protective hood can be rigidly mounted and at least partially covers the region of the cutting wheel that points toward the user. The region of the cutting wheel oriented away from the user is freely accessible and is used to machine a work piece.

In a circular saw known from actual use, the disk-shaped tool is comprised of an essentially circular disk-shaped sawblade. The sawblade can be almost completely shielded by means of a protective hood that can be pivoted essentially around the rotation axis of the sawblade. When the sawblade is inserted into a plate-like work piece to be machined, the protective cover opens either automatically or after a locking device is released. As soon as the sawblade is removed from the work piece to be machined, the protective cover closes automatically.

Advantages of the Invention

The invention is based on a hand power tool with a disk-shaped tool that can be driven to rotate, in particular of a manually guided right angle grinder, a manually guided circular saw, or the like, including a movable tool cover. According to the invention, the tool cover has an essentially curved end face and, in order to unblock the disk-shaped tool, is embodied so that it can move essentially parallel to the plane of the tool so that when actuated, the end face of the tool cover moves across at least part of the surface of the disk-shaped tool in a direction lateral to the circumference direction of the tool. A tool cover of this kind can be brought into the open position by means of pressure directed radially in relation to the disk-shaped tool against an arbitrary point on the curved end face, whose contour, for example, essentially follows the circumference of the disk-shaped tool in the closed position. The hand power tool according to the invention therefore makes it possible for the disk-shaped tool to be placed against a work piece in an essentially arbitrary direction in the region of the tool cover. The tool covering always unblocks the disk-shaped tool. The essentially curved end face reliably prevents the tool cover from getting caught on a work piece, even if the work piece has an uneven surface.

The tool cover effectively protects a user from unintentional contact with the disk-shaped tool, which is comprised for example of a synthetic resin-bonded cutting wheel or a sawblade with carbide cutting edges.

The tool cover is preferably supported so that it can pivot, which allows a support to easily be produced, which is not sensitive to dirt. In this connection, it has a pivot axis that is radially offset from the rotation axis of the disk-shaped tool. In principle, it is naturally also conceivable for the tool cover to be embodied so that it can slide.

The pivot axis is advantageously disposed laterally next to the disk-shaped tool. As a result, advantageous lever ratios, which occur when the tool or tool cover is pressed against a work piece, can be achieved over a large angular range of the tool and low. deflection forces of the tool cover can also be achieved. Furthermore, the pivot axis can be integrated in a structurally simple and space saving manner.

In another embodiment of the invention, the pivot axis is disposed on a side of the disk-shaped tool opposite from a handle, in particular an auxiliary handle, which permits a locking device to be integrated into a side oriented toward the handle and due to the favorable lever ratios, this locking device can be advantageously embodied in an inexpensive, easy, space-saving manner. However, it is also possible to dispose the pivot axis on the side oriented toward the handle, which permits a locking device to be integrated into the region of the pivot axis and handle in a particularly simple fashion, structurally.

The end face of the tool cover is advantageously at least partly embodied as a guide surface, which results in a simple operation of the hand power tool on a work piece surface.

So that the tool cover can be moved against the work piece to be machined in as frictionless as possible a manner, a sliding material is advantageously disposed on the end face of the tool cover. The sliding material can, for example, be comprised of Teflon or a plastic such as POM.

Since the sliding material is exposed to wear in the form of abrasion during use of the hand power tool, it is preferably embodied as replaceable. For example, a slide rail, which is comprised of POM for example, can be placed onto the end face of the tool cover by means of a snap connection. A slide rail, however, can also be fastened to the tool cover by other means deemed appropriate by one skilled in the art, for example screws, etc.

A material-saving, advantageously lightweight embodiment of the hand power tool according to the invention is comprised in the fact that the tool cover has an essentially sickel-shaped outline. An embodiment of this kind also assures that a large pivoting range and therefore working range are available without coming into conflict with the drive axis of the disk-shaped tool. However, it is also conceivable to embody the tool cover, for example, as semicircular. In this instance, it is likewise possible to provide the tool cover with a recess into which the drive axis of the disk-shaped tool is guided when the tool cover is being pivoted.

In a preferred embodiment of the hand power tool according to the invention, the tool cover is spring-loaded in the closing direction, which can assure that as soon as the disk-shaped tool is lifted up from the work piece, the tool cover automatically pivots back in its closing direction, thus protecting the user from the tool.

The tool cover advantageously has a locking device. With a locking device, it is possible to assure that the tool cover only unblocks the tool when there is a deliberate actuation or unlocking of the locking device while pressing against a work piece. The locking device can be embodied so that the tool cover can only be released with proper use of the hand power tool and the safety of the hand power tool can be increased.

According to another embodiment, the locking device is integrated at least partially into a handle, in particular an auxiliary handle or secondary handle. It is possible, in a structurally simple fashion, to assure that only when the handle is securely grasped can the locking device unlock, the tool cover move into its open position, and the hand power tool be used. Furthermore, the locking device can be integrated into the handle, in particular into a secondary handle, in a space-saving manner and with only a few additional parts, and in a particularly advantageous manner, an actuating element for releasing the lock can be integrated into it.

A particularly advantageous and secure tool cover is produced if it has a slot for the disk-shaped tool and covers the disk-shaped tool on both sides in the direction of a tool axis. When the hand power tool is used, the disk-shaped tool reaches through this slot in order to be inserted into a work piece. The slot can be let into a one-piece tool cover or can be disposed between two components, possibly individually suspended, that constitute the tool cover. These two components in turn can, individually or together, be spring-loaded in the closing direction. Moreover, for example one of the components can be sickle-shaped and the other component can be semicircular.

The tool cover can have a pivot guide, which assures and also supports a directed pivoting of the tool cover and can also serve as a second supporting point for it.

The hand power tool according to the invention can be provided with a cutting depth limiter, which allows savings of additional parts, assembly costs, and weight in comparison to a hand power tool with a separate cutting depth limiter. The cutting depth limiter can, for example, be comprised of a bolt-like stop for the tool cover, which stop is integrated into the pivot guide.

### DRAWINGS

Other advantages ensue from the following description of the drawings. The drawings show exemplary embodiments of the hand power tool according to the invention. The drawings, the specification, and the claims contain numerous features in combination. On skilled in the art will also suitably consider the features individually and will unite them into other appropriate combinations.

FIG. 1 shows a schematic depiction of a first embodiment of a manually guided right angle grinder according to the invention,

FIG. 2 shows a second embodiment,

FIG. 3 shows a third embodiment,

FIG. 4 shows a fourth embodiment,

FIG. 5 shows a schematic section along the line V-V in FIG. 4.

### DESCRIPTION OF THE EXEMPLARY EMBODIMENTS

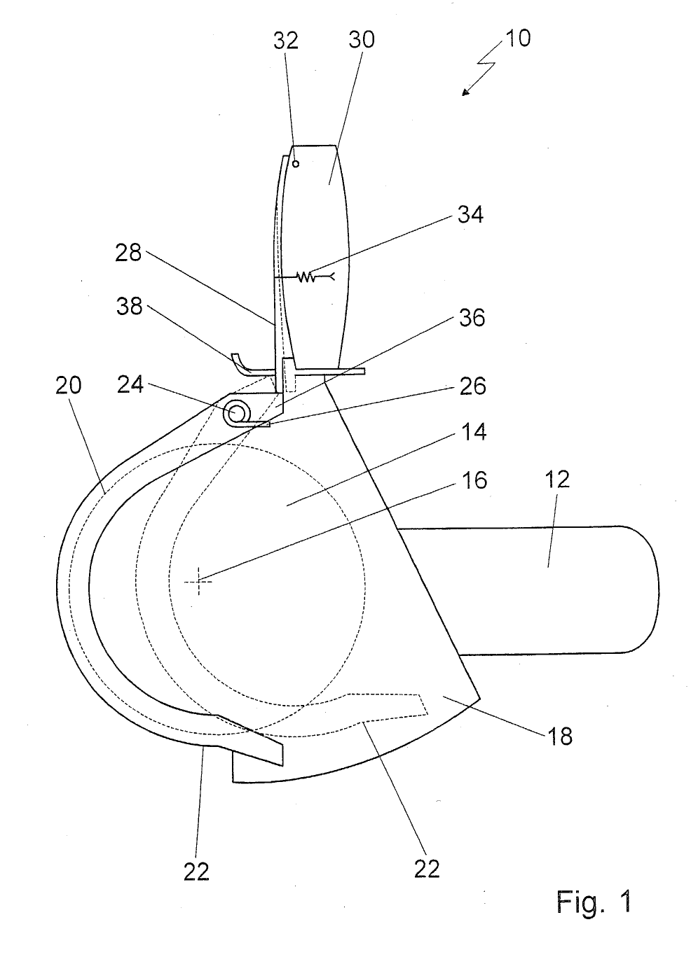

FIG. 1 shows a manually guided right angle grinder 10, which has an electrically actuated drive unit 12 to provide rotary drive for a synthetic resin-bonded cutting wheel 14 that is shown here with dashed lines. During operation of the right angle grinder 10, the cutting wheel 14 rotates around a rotation axis 16. The drive unit 12 can serve as a handle for a user of the right angle grinder.

A protective hood 18 is provided on the side of the cutting wheel 14 oriented toward the drive unit 12. The protective hood 18 is fastened to the drive unit 12, covers the cutting wheel 14 along the circumference oriented toward the user, and protects the user from the cutting wheel 14 and in particular, from cuttings that are accelerated outward by the cutting wheel 14.

The protective hood 18 is disposed on the side of the cutting wheel 14 that is disposed opposite a working region 20 of the cutting wheel 14, which region is used to machine a work piece. The working region 20 of the cutting wheel 14 is protected by means of a tool cover 22 according to the invention, which is supported so that it can pivot by means of a bolt 24 on the protective hood 18, which bolt constitutes a pivot axis. The bolt 24 is disposed laterally next to the cutting wheel 14, on a side oriented toward an auxiliary handle 30, which extends perpendicular to the drive unit 12.

The tool cover 22 is loaded toward its closed position by means of a spring 26 that engages the bolt 24. The closed position of the tool cover 22 corresponds to the position shown with solid lines in FIG. 1. In this position, the tool cover 22 covers the working region 20 of the cutting wheel 14 on both sides in the direction of the rotation axis 16. The tool cover 22 has a respective shell on each of the two sides of the cutting wheel 14 in the direction of the rotation axis 16. The two shells are each sickle-shaped in outline, with a curved end face, and define a slot in which the working region 20 of the cutting wheel 14 is disposed in the closed position of the tool cover 22 and which the cutting wheel 14 reaches through when it is inserted into a work piece. A working position of the tool cover 22, in which the working region 20 of the cutting wheel 14 is unblocked, is shown with dashed lines in FIG. 1.

In order to secure the closed position of the tool cover 22, the hand power tool 10 has a locking device with a locking element 28. The locking element 28 is embodied as key-like, is integrated into the auxiliary handle 30, and extends in the longitudinal direction of the auxiliary handle 30, on its side oriented toward the working region 20. The locking element 28 is fastened so that it can rotate on the auxiliary handle 30 by means of a bolt 32, which is disposed in the vicinity of the free end of the auxiliary handle 30 and serves as a pivot axis for the key-like locking element 28.

The locking element 28 is loaded in the direction of its locked position by means of a compression spring 34. In the locked position, the locking element 28 engages with a cam 36 formed onto the tool cover 22 in such a way that the locking element 28 is loaded with locking forces in its longitudinal direction. If the auxiliary handle 30 is grasped by a user and the locking element 28 is deflected toward the auxiliary handle 30, counter to the compression spring 34, into its released position, then the locking element 28 releases the cam of the tool cover 22 and the tool cover 22 can be pivoted over the cutting wheel 14 and the working position 20 of the cutting wheel 14 can be unblocked. The released position of the locking element 28 is depicted with dashed lines. On the side remote from the auxiliary handle 30, the tool cover 22 is guided in a groove, not shown in detail, of the protective hood 18.

The right angle grinder 10 also has a stop 38 for the tool cover 22. The maximal deflection of the tool cover 22, i.e. the stop position, is shown with dashed lines in FIG. 1.

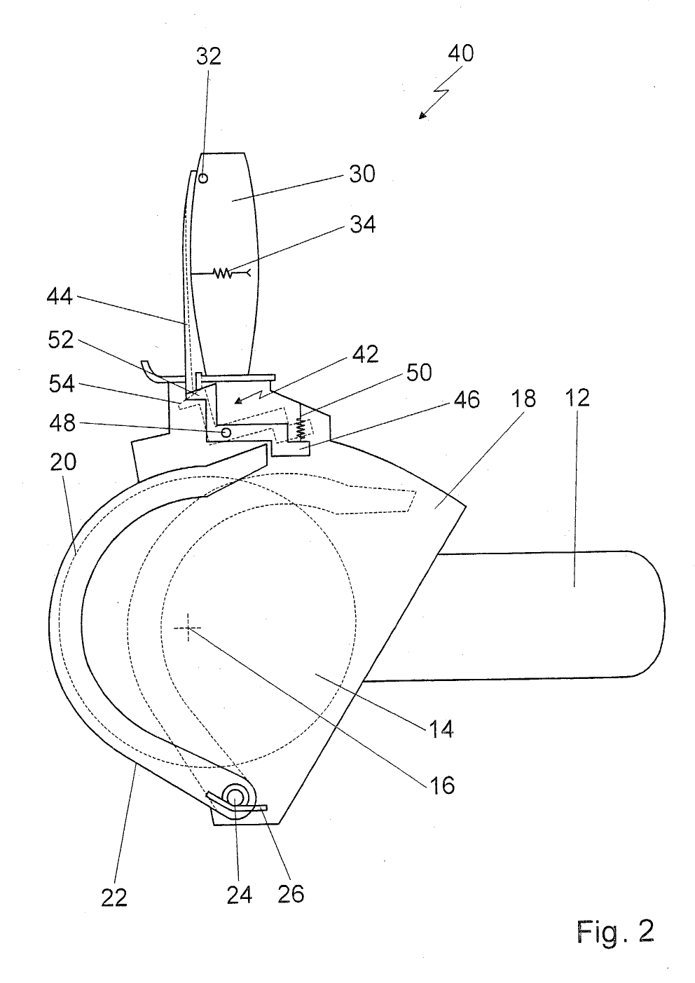

FIG. 2 shows an alternative embodiment of a right angle grinder 40. Components that are essentially the same in the exemplary embodiments shown are basically labeled with the same reference numerals. Furthermore, with regard to features and functions that remain unchanged, reference can be made to the description of the exemplary embodiment according to FIG. 1

The right angle grinder 40 differs from the right angle grinder according to FIG. 1 in that the tool cover 22 is supported on a bolt 24, which constitutes the pivot axis, on the side of the cutting wheel 14 oriented away from the auxiliary handle 30, and in the embodiment of a locking device 42. The locking device 24 includes a key 44, which is loaded in the locking direction by means of a compression spring 34, serves to release a locking bar 46, and is integrated into the auxiliary handle 30. The key 44 essentially corresponds to the locking element 28 of the exemplary embodiment in FIG. 1. The locking bar 46 is supported so that it can pivot on a bolt 48 and is loaded in the locking direction by means of a compression spring 50.

Upon actuation of the key 44, which is integrated into the auxiliary handle 30 and slides with its free end against an oblique plane 54 of a cam 52 formed onto the locking bar 46, the locking bar 46 is rotated counter to the spring force of the compression spring 50 so that when pressed against a work piece, the tool cover 22 can be pivoted toward the rotation axis 16 of the disk-shaped tool 14. The cutting wheel 14 is unblocked as it passes through the slot in the tool cover 22. If the right angle grinder 40 is removed from the work piece to be machined, then the tool cover 22 pivots back over the working region 20 of the cutting wheel 14 and engages in detent fashion with the locking bar 46.

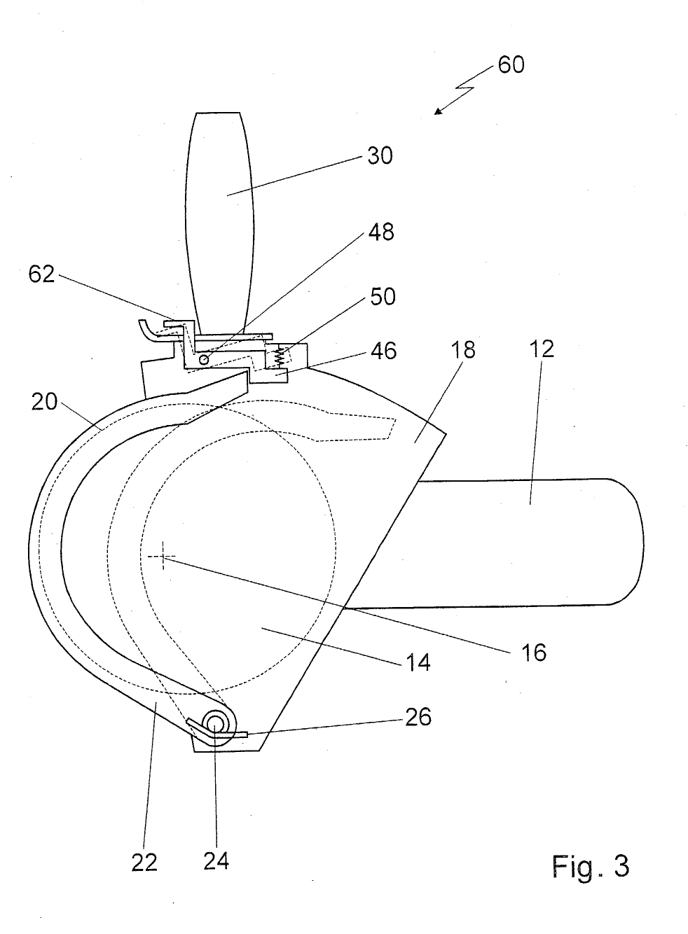

FIG. 3 depicts a right angle grinder 60, which differs from the one shown in FIG. 2 in that the locking bar 46 is not actuated by means of a key, but can be actuated by means of a release button 62, which is an integral component of the locking bar 46.

When the release button 62 is actuated, the locking bar 46 pivots around the bolt 48, counter to the spring force of the compression spring 50, into its release position so that when a work piece is being machined, the tool cover 22 can be pivoted toward the position shown with dashed lines. If the cutting wheel 14 is removed from the work piece, then the tool cover 22 automatically pivots back into its closed position and engages in detent fashion with the locking bar 46. The right angle grinder 60 is secured.

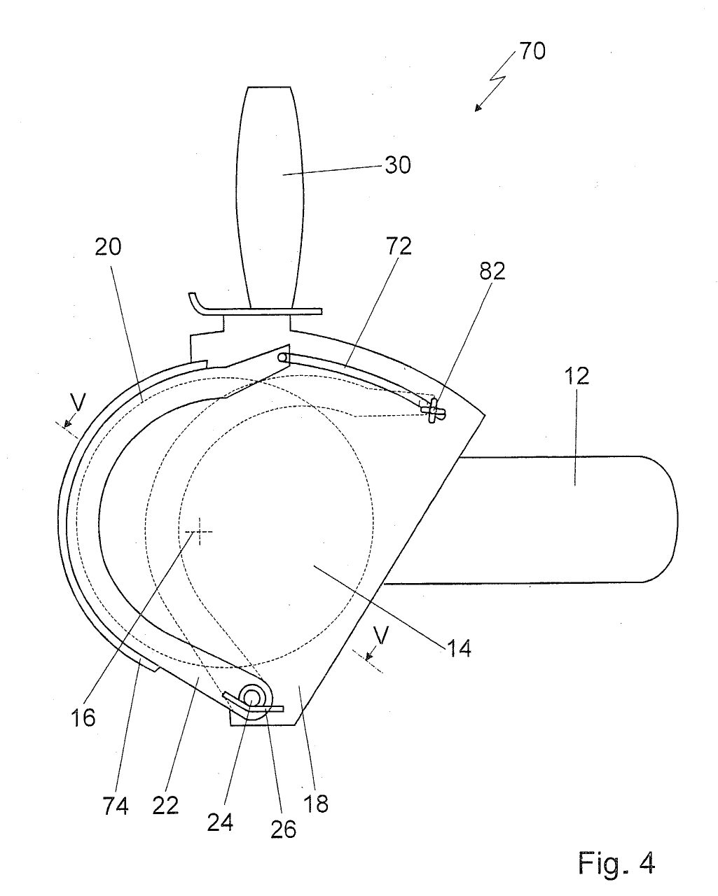

FIG. 4 shows a right angle grinder 70, which differs from the one shown in FIG. 3 in that it is provided with a guide rail 72 for the tool cover 22, which guide rail constitutes a pivot guide. The guide rail 72 is integrated into the protective hood 18 and is equipped with an adjustable cutting depth limiter comprised of a slidable bolt 82, which can be slid into any position and locked in place.

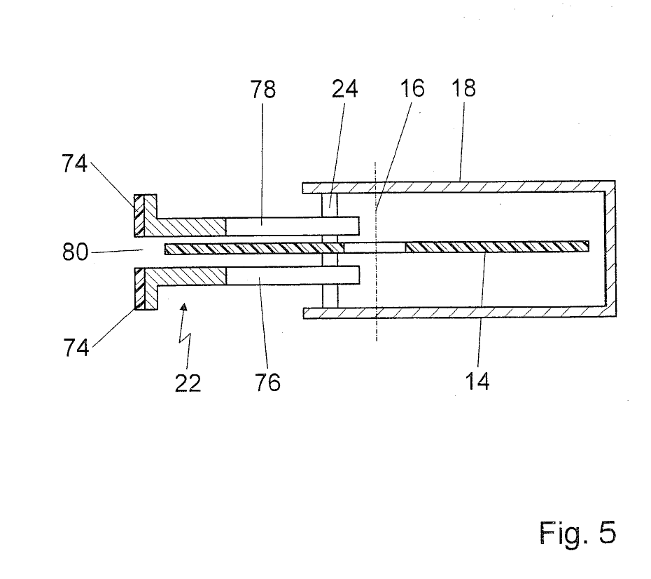

As can be inferred in particular from FIG. 5, the tool cover 22 has two shells 76, 78, which have an essentially L-shaped cross section and define a slot 80 for the cutting wheel 14. The L-shaped cross section can assure that the shells 76, 78 have wide end faces and can assure an advantageous guide behavior.

A replaceable slide rail 74 made of plastic is attached to the end faces of the shells 76, 78 of the tool cover 22 in the exemplary embodiment in FIGS. 4 and 5. The slide rails 74 constitute guide surfaces and make it easier to guide the right angle grinder 70 over a work piece.

Reference Numerals

| | |
|---|---|
| 10 | right angle grinder |
| 12 | drive unit |
| 14 | cutting wheel |
| 16 | rotation axis |
| 18 | protective hood |
| 20 | working region |
| 22 | tool cover |
| 24 | bolt |
| 26 | spring |
| 28 | locking element |
| 30 | auxiliary handle |
| 32 | bolt |
| 34 | compression spring |
| 36 | cam |
| 38 | stop |
| 40 | right angle grinder |
| 42 | locking device |
| 44 | key |
| 46 | locking bar |
| 48 | bolt |
| 50 | compression spring |
| 52 | cam |
| 54 | oblique plane |
| 60 | right angle grinder |
| 62 | release button |
| 70 | right angle grinder |
| 72 | guide rail |
| 74 | slide rail |
| 76 | shell |
| 78 | shell |
| 80 | slot |
| 82 | bolt |

1. A hand power tool with a disk-shaped tool (14) that can be driven to rotate, in particular a manually guided right angle grinder, a manually guided circular saw, or the like, including a movable tool cover (22), characterized in that the tool cover (22) has an essentially curved end face and is embodied so that it can move essentially parallel to the plane of the disk-shaped tool (14) in order to unblock this tool, that when actuated, the end face of the tool cover (22) moves across at least part of the surface of the disk-shaped tool (14) in a direction lateral to the circumference direction of the tool.

2. The hand power tool according to claim 1, characterized in that the tool cover (22) is supported so that it can pivot and has a pivot axis (24) that is radially offset from the rotation axis (16) of the disk-shaped tool (14).

3. The hand power tool according to claim 2, characterized in that the pivot axis (24) is disposed laterally next to the disk-shaped tool (14).

4. The hand power tool according to claim 3, characterized in that the pivot axis (24) is disposed on a side of the disk-shaped tool (14) opposite from a handle (30).

5. The hand power tool according to one of claims 1 to 4, characterized in that the end face of the tool cover (22) is at least partly embodied as a guide surface.

6. The hand power tool according to claim 5, characterized in that a sliding material (74) is disposed on the end face of the tool cover (22).

7. The hand power tool according to claim 6, characterized in that the sliding material (74) can be replaced.

8. The hand power tool according to one of claims 1 to 7, characterized in that the tool cover (22) has a sickle-shaped outline.

9. The hand power tool according to one of claims 1 to 8, characterized in that the tool cover (22) is spring-loaded in closing direction.

10. The hand power tool according to one of claims 1 to 9, characterized in that the tool cover (22) has a locking device (28, 42, 46).

11. The hand power tool according to claim 10, characterized in that the locking device (28, 42) is at least partly integrated into a handle (30).

12. The hand power tool according to one of claims 1 to 11, characterized in that the tool cover (22) has a slot (80) for the disk-shaped tool (14).

13. The hand power tool according to one of claims 1 to 12, characterized in that the tool cover (22) has a pivot guide (72).

14. The hand power tool according to one of claims 1 to 13, characterized in that the tool cover (22) cooperates with a cutting depth limiter.
